(19) United States
(12) Patent Application Publication
(10) Pub. No.: US 2017/0340985 A1
(43) Pub. Date: Nov. 30, 2017

(54) GAS DISTRIBUTION STRUCTURE FOR DISTILLATION COLUMN AND CONTROL METHOD THEREOF

(71) Applicant: Tianjin Aozhan Xinda Technology Co.,LTD., Tianjin (CN)

(72) Inventors: BING ZHANG, TIANJIN (CN); JIANMING LI, TIANJIN (CN); JIE RUAN, TIANJIN (CN); CHUNLU ZHANG, TIANJIN (CN)

(73) Assignee: Tianjin Aozhan Xinda Technology Co.,LTD.

(21) Appl. No.: 15/679,766

(22) Filed: Aug. 17, 2017

Related U.S. Application Data
(63) Continuation of application No. PCT/CN2015/076403, filed on Apr. 13, 2015.

(30) Foreign Application Priority Data
Feb. 17, 2015 (CN) 201510086163.0
Feb. 17, 2015 (CN) 201520114631.6

(51) Int. Cl. B01D 3/14; B01D 3/32; B01D 53/18; B01D 3/42; B01D 3/16; B01D 3/28

(52) U.S. Cl. CPC B01D 3/141; B01D 53/185; B01D 3/42; B01D 3/32; B01D 3/28; B01D 3/163

(57) ABSTRACT

The present invention discloses a gas distribution structure for a distillation column. Pressure drop adjusting column tray assemblies are arranged in a left mass transfer region and a right mass transfer region along a column height direction. The gas distribution structure includes column trays, gas-rising pipes, downcomers and cover hoods, wherein a gas flow meter is arranged in a pipe of any gas rising pipe; a feeding port and a liquid collecting port are formed in a column wall; a liquid flow meter, an adjusting valve and a circulation pump are arranged on a circulation pipeline between each liquid collecting port and each feeding port; technological parameters are transmitted to a control system; and the circulation pumps and the adjusting valves are controlled by the control system

### CROSS-REFERENCE TO RELATED APPLICATIONS

This application is a continuation of International Patent Application No. PCT/CN2015/076403 with a filing date of Apr. 13, 2015, designating the United States, now pending, and further claims priority to Chinese Patent Application No. 201510086163.0 with a filing date of Feb. 17, 2015 and Chinese Patent Application No. 201520114631.6 with a filing date of Feb. 17, 2015. The content of the aforementioned applications, including any intervening amendments thereto, are incorporated herein by reference.

### TECHNICAL FIELD

The present invention relates to a gas flow distribution and control system for a distillation column in chemical engineering, and particularly relates to a steady gas flow distribution and flow control method with high operational flexibility for gas-liquid mass transfer of a thermal coupling process or device.

### BACKGROUND OF THE PRESENT INVENTION

A rectification technological process is a high energy-consumption operating unit in industry, so engineers and researchers in various countries around the world research a problem about how to separate a multicomponent mixture at low cost and low energy consumption, extensively and deeply explore various different processes, devices and operating modes, particularly thermal coupling rectification represented by dividing wall rectification, and successfully realize many industrial apparatuses. Since 1985, BASF Company, UOP Company, Kohn-Glitch Company, Linde Company, Kellogg Company, Kyowa Yuka Company, Sunitomo Heavy Industries and other companies have started to use a dividing wall type distillation column mainly applied to fields of three-component separation, multicomponent separation, reactive rectification, extractive rectification, azeotropic rectification, etc. The dividing wall type distillation column has huge economic advantages of low energy consumption and low investment, and significant economic benefits for the multicomponent separation and special rectification, thereby attracting broad attention of professionals and scholars in various countries around the world.

The dividing wall type distillation column produces more operating degrees of freedom due to complexity of its structure and process, so energy conservation and acquisition of high-purity products are not easy and require internal variables of a system to have stronger controllability. Thus, a problem about controlling the division of the dividing wall type distillation column becomes a major factor hindering its industrial application. In particular, uprising gas entering the bottom of the dividing wall type distillation column is distributed on both sides of a dividing wall. A distribution value affects the purity of products and the energy consumption during rectification. An appropriate gas distribution value not only can reduce the energy consumption of the dividing wall type distillation column, but also can greatly improve the purity of rectification products, so problems about how to distribute and effectively control gas flow on both sides become a focus of attention of the industry. Relative to an ordinary distillation column, the dividing wall type distillation column needs to adjust liquid falling from an upper end of the dividing wall to both sides of the dividing wall and gas rising from the bottom of the column to both sides of the dividing wall simultaneously. Since the adjustment for distribution of the gas on both sides of the dividing wall involves a series of calculation processes such as complex hydraulic calculation, dynamic simulation of operating parameters, analysis of a gas-liquid two-phase flow field, etc., the adjustment and control for distribution of the gas on both sides of the dividing wall is quite difficult.

At present, a manner that the gas is freely distributed on both sides of the dividing wall is commonly adopted. A proportion of free distribution depends on internal members (such as filler height, the number of layers of column trays, areas of flow channels, etc.) of a dividing wall column and operating conditions in the column. The gas rising from the bottom of the column is automatically distributed to both sides of the dividing wall by following a rule that pressure drops of a left side and a right side are equal. Since changes in feed compositions and states, a liquid distribution proportion and the like may become important factors affecting the distribution of the gas, a flow ratio of gases automatically distributed to both sides of the dividing wall often cannot reach an optimal operation condition of the dividing wall column.

Another solution for adjustment and control of gas distribution is that a special internal member is designed to change the composition of the pressure drops of both sides of the dividing wall so as to achieve a purpose of adjusting the gas phase distribution, or a division wall is placed eccentrically. For example, a movable dividing wall is mounted at the bottom of the dividing wall. Circulation areas of both sides of the dividing wall are changed by changing a position of the dividing wall so as to change a gas phase distribution ratio. The pressure drops of both sides of the dividing wall are changed by using the internal member or placing the division wall eccentrically, so that the operating flexibility and the sensitivity are low, and the device cannot operate stably for a long period due to mechanical wear caused by movement of the dividing wall.

The patent literature PCT/US2011/056079 published on Mar. 5, 2012 discloses a dividing wall fractionation column and a gas-liquid flow control method thereof. As shown in FIG. 1, the dividing wall fractionation column comprises a column body 100, a gas phase collection and distribution structure 200 and a liquid phase acquisition and distribution structure 300, wherein gas collection and distribution mainly refer to realizing gas distribution and control through bypass gas phase pipelines 54a and 54b provided with adjusting valves 56a and 56b and flow meters 58a and 58b outside the column in combination with automatic control. The technical solution has major defects that: firstly, gas phase redistribution apparatuses need to be arranged in the column when the gas phase is led out and the gas phase enters the column again, causing an increase of the column height and the complexity of internal parts; secondly, for the dividing wall column with relatively high production and processing capabilities, diameters of the bypass gas phase pipelines 54a and 54b may be very large, and installation and maintenance of relevant components are inconvenient; thirdly, for the bypass gas phase pipelines 54a and 54b provided with the adjusting valves 56a and 56b and the flow meters 58a and 58b, not only the column height is increased, but also a characteristic of gas flowing pressure drop becomes quite complicated; excessive pressure drop may cause flooding of liquid in the downcomer 48 below the dividing wall 120, and the system cannot work normally; and finally, sizes of the adjusting valves 56a and 56b are changed with scales of the apparatuses, and the investment will become quite expensive. More importantly, almost no valve in valve types of the prior art can sensitively and accurately adjust and control the gas phase flow within a range of relatively low resistance drop.

The Chinese invention patent No. 201320829355.2 published on Jun. 4, 2014 discloses a gas allocation apparatus for a dividing wall column. As shown in FIG. 2, the gas allocation apparatus adopts a flow detection apparatus 31, a controller 33, a barrel body 24, a dividing wall 22, a square division groove 26, a downcomer 27, a gas inlet channel 25, a square valve adjusting mechanism 28, a sleeve 29, a rotating shaft 30, a motor 32 and a gas distribution mechanism 23. The apparatus mainly has design defects that: firstly, when square valves are used for adjusting the gas flow, defects such as irregular adjustment and control performance curve, hard fine adjustment, poor adjustment and control regularity, nonlinear gas volume, etc. are present; secondly, after a gas volume is fed back to a mass transfer region on an upper side of the dividing wall 22, the resistance drop reaction of the gas on both sides of the dividing wall 22 is delayed and negative feedback appears after feeding back to a controller 33; the square valves do not have the characteristic of fine adjustment, causing that the square valve adjusting mechanism continuously performs positive and negative adjustment actions, and steady adjustment is hard to realize; thirdly, since the square valves are used for adjusting an opening degree, the gas flow behind the valves is centered on a turbulence form, and the flow detection apparatus is difficult to detect the actual gas flow accurately; and finally, since a transmission component is arranged in the column, it is difficult to solve problems of lubrication and wearing, which may affect long-term normal operation of the device.

A large number of operating variables are present in a thermal coupling technology of the dividing wall type distillation column and many parameters are coupled with each other, and particularly a physical relationship of the gas flow and other variables on both sides of the dividing wall is relatively complicated. Thus, many scholars and researchers in China and abroad think this parameter cannot becomes a directly controllable variable, but the effective distribution and stable control of the gas on both sides of the dividing wall are important means to ensure a product index and reduce the energy consumption. If a technological control target cannot be reached, advanced property and economy of the dividing wall type distillation column will be greatly degraded. The technical solutions for a gas flow distribution and control manner in China and abroad still have many defects. Advanced technical means are urgently needed to solve this industrial problem.

### SUMMARY OF PRESENT INVENTION

In view of deficiencies in the prior art, the present invention provides a pressure drop adjusting column tray assembly for gas distribution of a distillation column and a gas distribution structure. The gas distribution structure is simple and relatively low in cost. The gas distribution structure for distribution and control is easy to operate, flexible and reliable in adjustment, high in sensitivity, and capable of ensuring long-term stable operation of the distillation column.

In order to solve the above technical problems, the present invention proposes a pressure drop adjusting column tray assembly for gas distribution of the distillation column. The pressure drop adjusting column tray assembly comprises pressure drop adjusting column trays. Downcomers and gas-rising pipes are penetrated on the pressure drop adjusting column trays. A plurality of rows of liquid-falling holes are formed in a pipe wall of each downcomer. A cover hood provided with sieve holes is arranged on each gas-rising pipe.

Preferably, the number of the downcomers on each pressure drop adjusting column tray is P, wherein P is greater than or equal to 1 and less than or equal to 100; P is an integer; preferably, P is an integer of 1-20; and particularly, P may be 1, 2, 3, 4, 5, 6, 7, 8, 9 or 10. Preferably, the number of the gas-rising pipes on each pressure drop adjusting column tray is Q, wherein Q is greater than or equal to 1 and less than or equal to 100; Q is an integer; preferably, Q is an integer of 1-20; and particularly, Q may be 1, 2, 3, 4, 5, 6, 7, 8, 9 or 10. Preferably, the number P of the downcomers is greater than the number Q of the gas-rising pipes; and the downcomers are distributed on both sides of the gas-rising pipes. It should be known by those skilled in the art that the number of downcomers and the number of the gas-rising pipes can also be set in a manner of being greater than 100 according to actual conditions (such as a scale of an apparatus and other factors).

Preferably, the top of each downcomer is higher than the uppermost sieve hole in the cover hood. A pressure drop is increased with the increase of a liquid level. When the liquid level above the pressure drop adjusting column tray is higher than the sieve hole, the sieve holes in the cover hood are completely covered by liquid, and the gas in the gas-rising pipes can only penetrate through a liquid layer and overflow at this time, so the pressure drop is further increased. When the liquid completely covers the sieve holes, the liquid level is further increased. A resistance adjustment effect is directly related to the increased liquid level. More preferably, the top of each downcomer is 30-60 mm higher than the uppermost sieve hole in the cover hood.

Preferably, the gas-rising pipe has an inner diameter of 30 mm-300 mm. The height from the top of the gas-rising pipe to an upper plane of the pressure drop adjusting column tray is 50 mm-250 mm.

Preferably, the cover hood is arranged coaxially with the gas-rising pipe on which the cover hood is located. The cover hood is fixed to the pressure drop adjusting column tray. A gap is reserved between the bottom of the cover hood and the pressure drop adjusting column tray, wherein the gap is 5-30 mm. A gap of 10-50 mm is reserved between the top of the cover hood and the top of the gas-rising pipe. More preferably, the sieve holes are of a circular, square, rhombic or elliptical shape. The cover hood is of circular, square, rhombic, elliptical or other polygonal shapes. It should be known by those skilled in the art that shapes of the sieve holes and the cover hood may be other shapes and are not limited in the present invention.

Preferably, each downcomer is embedded in the pressure drop adjusting column tray. Each liquid-falling hole has a diameter of 0.5-10 mm. The number of the liquid-falling holes in each row is 1-5. More preferably, the downcomers are any one of square pipes, circular pipes and elliptical pipes. A plurality of sieve holes are distributed along a height direction of the cover hood in a plurality of rows. Each row has at least one sieve hole. Specifically, each row has a plurality of sieve holes. It should be known by those skilled in the art that the distribution of the sieve holes is not limited to uniform arrangement, and can also be irregular arrangement. Shapes of the downcomers can also be other shapes and are not limited in the present invention.

Specifically, the present invention proposes a pressure drop adjusting column tray assembly for gas distribution of a dividing wall type distillation column. The pressure drop adjusting column tray assembly comprises pressure drop adjusting column trays. Downcomers and gas-rising pipes are penetrated on the pressure drop adjusting column trays and are arranged in such a manner that the top of each downcomer is higher than the top of each gas-rising pipe. A plurality of rows of liquid-falling holes are formed in a pipe wall of each downcomer. A cover hood provided with sieve holes is arranged on each gas-rising pipe.

The present invention further proposes a gas distribution structure for a distillation column. The distillation column comprises a control system, a left mass transfer region and a right mass transfer region.

Pressure drop adjusting column tray assemblies are arranged in the left mass transfer region and/or the right mass transfer region along a column height direction. Each pressure drop adjusting column tray assembly comprises a pressure drop adjusting column tray. Downcomers and gas-rising pipes are fixed on the pressure drop adjusting column trays in a penetrating manner. A plurality of rows of liquid-falling holes are formed in a pipe wall of each downcomer. A cover hood provided with sieve holes is arranged on each gas-rising pipe. At least one gas flow meter is respectively in the left mass transfer region and/or the right mass transfer region. The gas flow meters are located in a pipe of any gas-rising pipe. A feeding port is arranged above each layer of pressure drop adjusting column tray. Liquid collecting regions are respectively arranged in the left mass transfer region and/or the right mass transfer region. Liquid accumulating type liquid-falling grooves are formed in the liquid collecting regions. Each liquid collecting region further comprises a liquid collecting port. A circulation pump is communicated with each liquid accumulating type liquid-falling groove through the liquid collecting port. The feeding port is connected to the circulation pump through a circulation pipeline. A liquid flow meter and an adjusting valve are arranged on the circulation pipeline. The gas flow meter and the liquid flow meter transmit signals to the control system. The circulation pump and the adjusting valve are controlled by the control system.

Preferably, the gas distribution structure for the distillation column further comprises a common mass transfer region. More preferably, the common mass transfer region comprises a rectification section common mass transfer region and/or a stripping section common mass transfer region.

Preferably, the distillation column is a dividing wall type distillation column. The dividing wall type distillation column comprises a dividing wall. The left mass transfer region and the right mass transfer region are arranged on a left side and a right side of the dividing wall. The rectification section common mass transfer region and the stripping section common mass transfer region are respectively located above and below the dividing wall.

Preferably, the left mass transfer region and the right mass transfer region are respectively located in separate column bodies. The left mass transfer region is communicated with the right mass transfer region through a pipeline. More preferably, the pipeline is located in the rectification section common mass transfer region and/or the stripping section common mass transfer region.

Preferably, the control system is selected from a distributed control system, a logic programming control system and a fieldbus control system.

Preferably, the numbers of layers of the pressure drop adjusting column tray assemblies in the left mass transfer region and the right mass transfer region are respectively M and N. Preferably, M is greater than or equal to 0 and less than or equal to 20; N is greater than or equal to 0 and less than or equal to 20; and M and N are integers and are not equal to 0 at the same time. More preferably, M and N are respectively an integer of 1-10, for example, 2, 3, 4, 5, 6, 7, 8 and 9 layers. M and N may be the same and may also be different. It should be known by those skilled in the art that the number of the pressure drop adjusting column tray assemblies can be adjusted according to actual demands (for example, according to composition, nature and content of a component to be separated, separation precision of a product, operating flexibility of an apparatus, resistance size of a mass transfer section and hydrodynamic characteristics of internal parts).

Preferably, the number of the downcomers on each pressure drop adjusting column tray is P, wherein P is greater than or equal to 1 and less than or equal to 100; P is an integer; preferably, P is an integer of 1-20; and particularly, P is 1, 2, 3, 4, 5, 6, 7, 8, 9 or 10. Preferably, the number of the gas-rising pipes on each pressure drop adjusting column tray is Q, wherein Q is greater than or equal to 1 and less than or equal to 100; Q is an integer; preferably, Q is an integer of 1-20; and particularly, Q may be 1, 2, 3, 4, 5, 6, 7, 8, 9 or 10. Preferably, the number P of the downcomers is greater than the number Q of the gas-rising pipes; and the downcomers are distributed on both sides of the gas-rising pipes. It should be known by those skilled in the art that the number of downcomers and the number of the gas-rising pipes can also be set in a manner of being greater than 100 according to actual conditions (such as a scale of an apparatus and other factors).

Preferably, the top of each downcomer is higher than the uppermost sieve hole in the cover hood. A pressure drop is increased with the increase of a liquid level. When the liquid level above the pressure drop adjusting column tray is higher than the top of the gas-rising pipe, the sieve holes in the cover hood are completely covered by liquid, and the gas in the gas-rising pipes can only penetrate through a liquid layer and overflow at this time, so the pressure drop is further increased. When the liquid completely covers the sieve holes, the liquid level is further increased. The resistance adjustment effect is directly related to the increased liquid level. More preferably, the top of each downcomer is 30-60 mm higher than the uppermost sieve hole in the cover hood.

Preferably, the gas-rising pipe has an inner diameter of 30 mm-300 mm. The height from the top of the gas-rising pipe to an upper plane of the pressure drop adjusting column tray is 50 mm-250 mm.

Preferably, the cover hood is arranged coaxially with the gas-rising pipe on which the cover hood is located. The cover hood is fixed to the pressure drop adjusting column tray. A gap is reserved between the bottom of the cover hood and the pressure drop adjusting column tray, wherein the gap is 5-30 mm. A gap of 10-50 mm is reserved between the top of the cover hood and the top of the gas-rising pipe. More preferably, the sieve holes are of a circular, square, rhombic or elliptical shape. The cover hood is of circular, square, rhombic, elliptical or other polygonal shapes. It should be known by those skilled in the art that shapes of the sieve holes and the cover hood may be other shapes and are not limited in the present invention.

Preferably, each downcomer is embedded in the pressure drop adjusting column tray. Each liquid-falling hole has a diameter of 0.5-10 mm. The number of the liquid-falling holes in each row is 1-5. More preferably, the downcomers are any one of square pipes, circular pipes and elliptical pipes. A plurality of sieve holes are distributed along a height direction of the cover hood in a plurality of rows. Each row has at least one sieve hole. Specifically, each row has a plurality of sieve holes. It should be known by those skilled in the art that the distribution of the sieve holes is not limited to uniform arrangement, and can also be irregular arrangement. Shapes of the downcomers can also be other shapes and are not limited in the present invention.

Preferably, the numbers of the liquid collecting regions in the left mass transfer region and the right mass transfer region are J and K, wherein J is greater than or equal to 0 and less than or equal to 20; K is greater than or equal to 0 and less than or equal to 20; and J and K are integers and are not equal to 0 at the same time. More preferably, the numbers J and K of the liquid collecting regions are integers greater than or equal to 1 respectively, can be the same as the number of the pressure drop adjusting column tray assemblies, and can also be less than the number of the pressure drop adjusting column tray assemblies.

Preferably, gas-rising cap column trays are arranged in the liquid collecting regions. A liquid accumulating type liquid-falling groove is formed between a side surface of each gas-rising cap column tray and the column wall of the distillation column. A liquid collecting port is formed in a position on the column wall and on a lower side surface of each liquid accumulating type liquid-falling groove. Preferably, the gas-rising cap column trays are of a chimney shape. It should be known by those skilled in the art that the shape of the gas-rising cap column tray is not limited to the chimney shape and can also be of rectangular, arc or other shapes.

Preferably, the height of a groove plate of the liquid accumulating type liquid-falling groove is 300-800 mm.

Preferably, the gas distribution structure further comprises pressure gauges and thermometers. The pressure gauges are arranged in regions formed between adjacent pressure drop adjusting column trays. The thermometers are arranged in the left mass transfer region and the right mass transfer region. The pressure gauges and the thermometers transmit signals to the control system.

Preferably, the position of the liquid collecting region comprises one or more of the following situations:

1) the liquid collecting region is located between the stripping section common mass transfer region and the lowermost pressure drop adjusting column tray assembly;

2) the liquid collecting region is located below the lowermost pressure drop adjusting column tray assembly between adjacent mass transfer regions; and

3) the liquid collecting region is located below the pressure drop adjusting column tray of the pressure drop adjusting column tray assembly.

When the position of the liquid collecting region is the above situation 1), a circulation pump is connected outside the liquid collecting port; and all the feeding ports are connected to the circulation pump through a circulation pipeline.

When the position of the liquid collecting region is the above situation 2), the circulation pump is connected outside the liquid collecting port; and all the feeding ports between the adjacent mass transfer regions are respectively connected to the circulation pump through the circulation pipeline.

When the position of the liquid collecting region is the above situation 3), the circulation pump is connected outside the liquid collecting port below the pressure drop adjusting column tray; and the feeding port located above the pressure drop adjusting column tray is connected to the circulation pump through the circulation pipeline.

Specifically, the present invention proposes a gas distribution structure for a dividing wall type distillation column. The dividing wall type distillation column comprises a column wall, a dividing wall, a multi-section mass transfer region, a control system and at least one liquid collecting region. The multi-section mass transfer region comprises a rectification section common mass transfer region arranged above the dividing wall, a left mass transfer region of the dividing wall, a right mass transfer region of the dividing wall and a stripping section common mass transfer region arranged below the dividing wall. Several layers of pressure drop adjusting column tray assemblies are arranged in the left mass transfer region of the dividing wall and the right mass transfer region of the dividing wall and between two adjacent mass transfer regions along the column height direction. The pressure drop adjusting column tray assemblies comprise pressure drop adjusting column trays. A plurality of downcomers and a plurality of gas-rising pipes are fixed on the pressure drop adjusting column trays in a penetrating manner and are arranged in such a manner that the top of each downcomer is higher than that of each gas-rising pipe. A plurality of rows of liquid-falling holes are formed in a pipe wall of each downcomer. A cover hood provided with sieve holes is arranged on each gas-rising pipe. A gas flow meter is arranged in each of the left mass transfer region of the dividing wall and the right mass transfer region of the dividing wall. The gas flow meter is located in a pipe of one gas-rising pipe. Feeding ports are respectively formed in a column wall and above the pressure drop adjusting column tray of each layer of pressure drop adjusting column tray assembly. A chimney type gas-rising cap column tray is arranged in each liquid collecting region. A liquid accumulating type liquid-falling groove is formed between the side surface of each chimney type gas-rising cap column tray and the column wall. A liquid collecting port is formed in a position on the column wall and on a lower side surface of each liquid accumulating type liquid-falling groove.

The position of the liquid collecting region comprises one or more of the following situations:

1) the liquid collecting region is located between the stripping section common mass transfer region and the lowermost pressure drop adjusting column tray assembly;

2) the liquid collecting region is located below the lowermost pressure drop adjusting column tray assembly between adjacent mass transfer regions; and

3) the liquid collecting region is located below the pressure drop adjusting column tray of the pressure drop adjusting column tray assembly.

When the position of the liquid collecting region is the above situation 1), a circulation pump is connected outside the liquid collecting port; and all the feeding ports are connected to the circulation pump through a circulation pipeline.

When the position of the liquid collecting region is the above situation 2), the circulation pump is connected outside the liquid collecting port; and all the feeding ports between the adjacent mass transfer regions are respectively connected to the circulation pump through the circulation pipeline.

When the position of the liquid collecting region is the above situation 3), the circulation pump is connected outside the liquid collecting port below the pressure drop adjusting column tray; and the feeding port located above the pressure drop adjusting column tray is connected to the circulation pump through the circulation pipeline.

A liquid flow meter and an adjusting valve are sequentially arranged on each circulation pipeline from the circulation pump to the feeding port. Pressure gauges are arranged in regions formed between adjacent pressure drop adjusting column trays. Thermometers are respectively arranged at positions of sensitive plates in the left mass transfer region of the dividing wall and the right mass transfer region of the dividing wall. All the gas flow meters, liquid flow meters, pressure gauges and thermometers transmit signals to the control system. The circulation pumps and the adjusting valves are controlled by the control system.

The present invention also proposes a method for realizing gas distribution and control of a distillation column by using the gas distribution structure. The gas distribution and control of the distillation column are realized through a coordination effect of the circulation pumps, the adjusting valves, the flow meters and the control system in the gas distribution structure of the present invention. The control system controls the circulation pumps and the adjusting valves. The liquid flow meters and the gas flow meters feed back current technological parameters to the control system. The control system issues a command for controlling the circulation pumps and the adjusting valves again according to a set technological control target until the fed-back technological parameters meet the technological control target. In the entire control process, the change of a liquid flow of each layer of pressure drop adjusting column tray can control a gas phase circulation area and a gas-liquid contact form, and then is converted into a gas phase flowing resistance drop, so as to effectively adjust and control a gas distribution ratio of regions on both sides.

Preferably, when the gas distribution structure comprises the pressure gauges and the thermometers, the pressure gauges and the thermometers feed back the current technological parameters to the control system. Materials at different temperatures or pressures have different boiling points. In order to further improve the gas distribution precision and then improve the rectification precision and save energy consumption, the pressure gauges and the thermometers are adopted to measure the current differential pressure and temperature, to precisely adjust and control the gas distribution in combination with gas flow parameters measured by the gas flow meters.

Preferably, the control system is selected from a distributed control system, a logic programming control system or a fieldbus control system.

Compared with the prior art, the present invention has beneficial effects that:

(1) the gas distribution structure for the distillation column in the present invention adopts a combination of conventional fluid transportation and control devices, is mature in technology and easy to be realized, can acquire a plurality of signals such as pressure, flow, temperature, etc. in real time, and is convenient to realize an overall-column control solution and strategy;

(2) in the control method of the present invention, the gas flow is slightly changed by finely adjusting a difference between pressure drops of regions on the left side and the right side; the flow of both sides can also be greatly adjusted by greatly adjusting the difference between resistance drops of both sides, and therefore, the method is high in operating flexibility;

(3) the distillation column having the gas distribution structure of the present invention can serve as a gas-liquid distributor because gas and liquid flow uniformly during operation, thereby saving space in the column; and

(4) the gas distribution structure of the present invention is not easy to be worn and damaged during use because no mobile device is arranged in the column body, can be operated fora long term, and is convenient for maintenance, assembly and disassembly, overhauling and cleaning.

In summary, a new internal part structure and an external control technology are designed with respect to changes of parameters such as an energy consumption index, raw material composition, a feed state, product quality, etc. of a system in the present invention, so as to reduce the overall control difficulty of the distillation column and enhance adaptability and controllability of the distillation column and the control system thereof.

### DESCRIPTION OF THE DRAWINGS

FIG. 1 is a structural schematic diagram of a dividing wall fractionation column in the prior art;

FIG. 2 is a structural schematic diagram of a gas allocation apparatus for a dividing wall type distillation column in the prior art;

FIG. 3-1 is a schematic diagram of embodiment 1 of a gas distribution structure for a dividing wall type distillation column of the present invention;

FIG. 3-2 is a schematic diagram of embodiment 2 of a gas distribution structure for a dividing wall type distillation column of the present invention;

FIG. 3-3 is a schematic diagram of embodiment 3 of a gas distribution structure for a dividing wall type distillation column of the present invention;

FIG. 4 shows a gas distribution structure of a twin-column type distillation column of the present invention;

FIG. 5 is a schematic diagram of a flow trajectory of gas-rising gas flow passing through pressure drop adjusting column trays in a dividing wall type distillation column of the present invention;

FIG. 6-1 is a schematic diagram of an appearance of a combined structure of gas-rising pipes and cover hoods of pressure drop adjusting column trays in the present invention;

FIG. 6-2 is a sectional view of a combined structure of gas-rising pipes and cover hoods of pressure drop adjusting column trays shown in FIG. 5-1; and

FIG. 7 is a schematic diagram of a gas distribution control mode for a distillation column of the present invention.

1—column wall; 2—chimney type column tray; 3—gas flow meter;

4—pressure drop adjusting column tray; 5—gas-rising pipe; 6—cover hood;

7—downcomer; 8—dividing wall; 9—left mass transfer region;

10—right mass transfer region; 11—pressure gauge; 12—liquid flow meter;

13—adjusting valve; 14—circulation pump; 15—stripping section common mass transfer region;

16—liquid-falling hole; 17—sieve hole; 18—supporting rib plate; and

19—rectification section common mass transfer region.

### DETAILED DESCRIPTION OF PREFERRED EMBODIMENTS

Technical solutions of the present invention are further described in detail below in combination with drawings and specific embodiments. The described specific embodiments are only used for illustrating the present invention, rather than limiting the present invention.

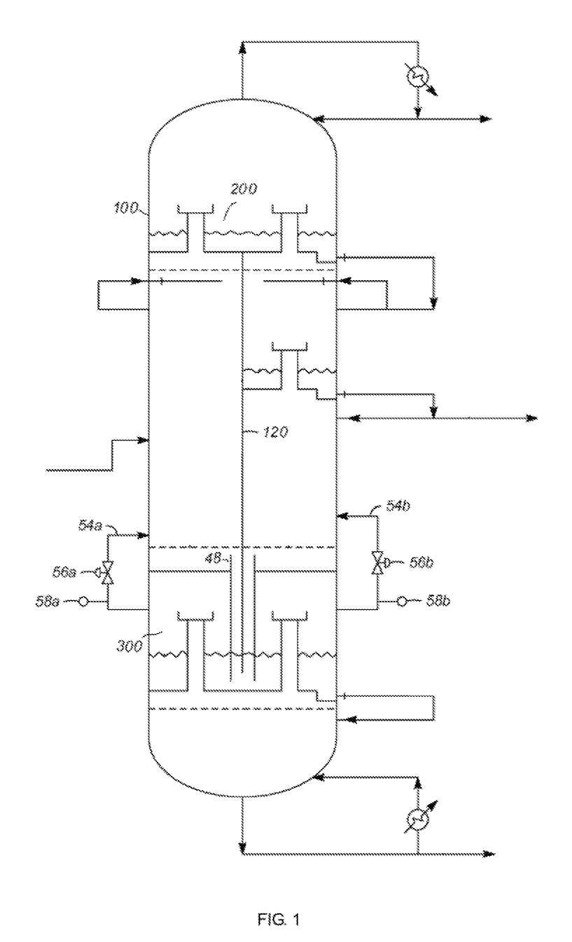

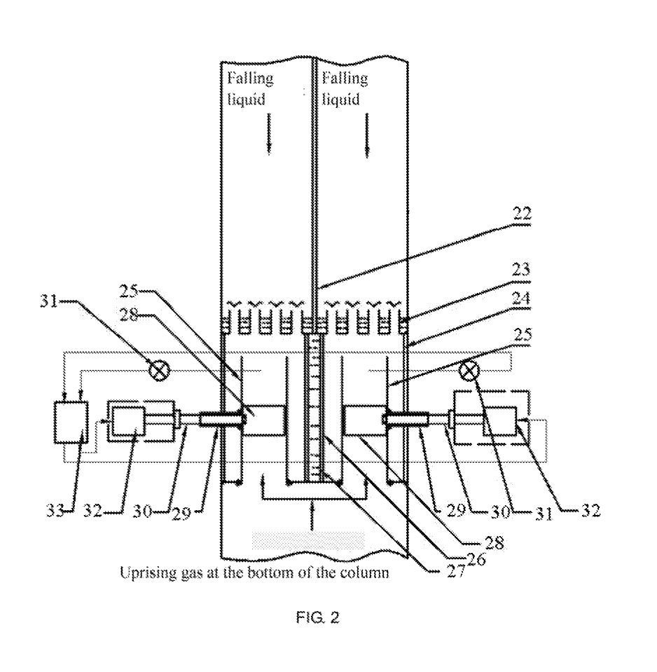

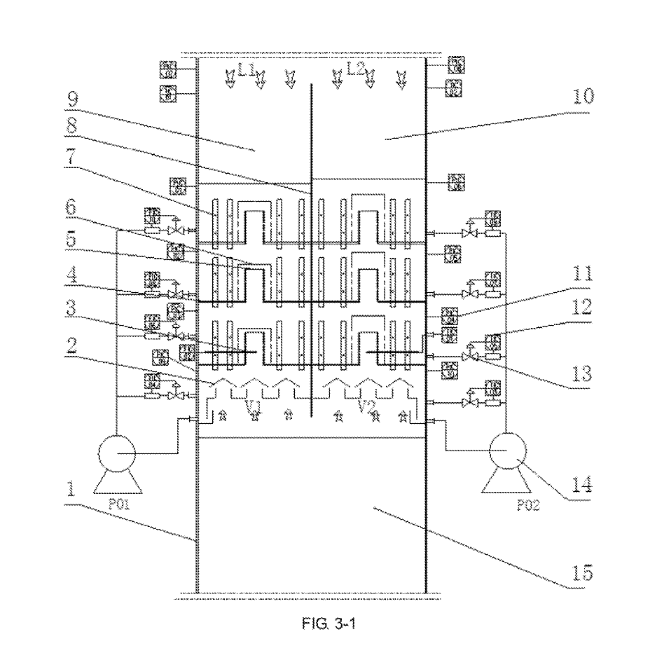

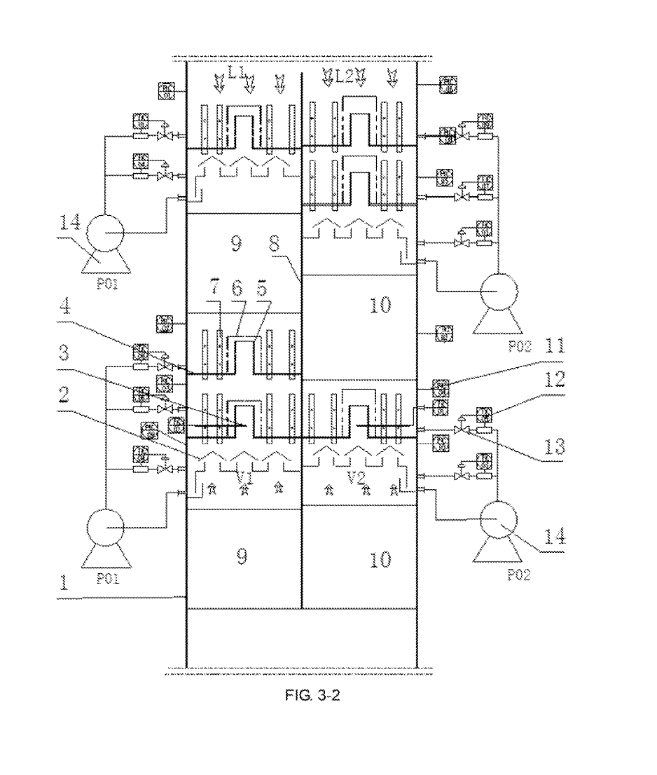

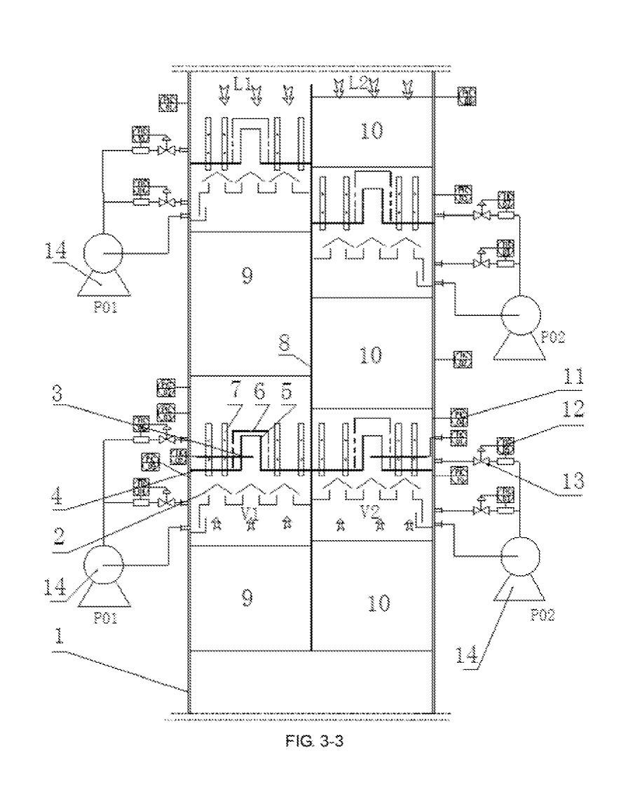

As shown in FIG. 3-1, FIG. 3-2 and FIG. 3-3, the present invention provides a gas distribution structure for a dividing wall type distillation column. The dividing wall type distillation column comprises a column wall 1, a dividing wall 8 and a control system, wherein a left mass transfer region 9 and a right mass transfer region 10 are respectively arranged in regions on both sides of the dividing wall 8. The left mass transfer region 9 and/or the right mass transfer region 10 may respectively comprise one or more mass transfer regions. Pressure drop adjusting column tray assemblies are arranged in the left mass transfer region 9 and/or the right mass transfer region 10 along a column height direction.

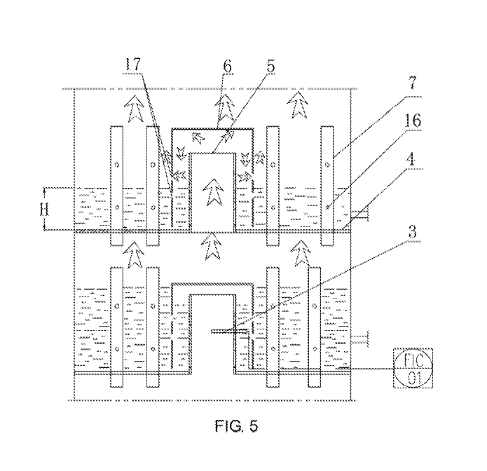

The pressure drop adjusting column tray assemblies comprise pressure drop adjusting column trays 4. Downcomers 7 and gas-rising pipes 5 are fixed on the pressure drop adjusting column trays 4 in a penetrating manner. A plurality of rows of liquid-falling holes 16 are formed in a pipe wall of each downcomer 7. The downcomers 7 are embedded in the pressure drop adjusting column trays 4. A cover hood 6 provided with sieve holes 17 is arranged on each gas-rising pipe 5. At least one gas flow meter 3 is arranged in each of regions on both sides of the dividing wall. The gas flow meter 3 is located in a pipe of any gas-rising pipe 5. The gas flow meters instantly transmit gas flow signals to a control system, as shown in FIG. 5.

Liquid collecting regions are arranged in the left mass transfer region 9 and/or the right mass transfer region 10. A feeding port is respectively formed in a position on the column wall 1 and above the pressure drop adjusting column tray 4 of each layer of pressure drop adjusting column tray assembly. Liquid accumulating type liquid-falling grooves are formed in the liquid collecting regions. The liquid collecting regions further comprise liquid collecting ports. Circulation pumps 14 are communicated with the liquid accumulating type liquid-falling grooves through the liquid collecting ports (specifically, in such a setting manner that a liquid collecting port is formed in a position on the column wall 1 and on a lower side surface of the liquid accumulating type liquid-falling groove, and a circulation pump 14 is connected outside the liquid collecting port). The feeding ports are connected to the circulation pumps 14 through circulation pipelines. Liquid flow meters 12 and adjusting valves 13 are arranged on the circulation pipelines. The gas flow meters 3 and the liquid flow meters 12 transmit signals to the control system. The circulation pumps 14 and the adjusting valves 13 are controlled by the control system.

In a specific embodiment of the present invention, the dividing wall type distillation column can further comprise a rectification section common mass transfer region arranged above the dividing wall 8 and/or a stripping section common mass transfer region 15 arranged below the dividing wall 8. FIG. 3 shows a situation of comprising the rectification section common mass transfer region and the stripping section common mass transfer region. It should be known by those skilled in the prior art that the dividing wall type distillation column can also comprise only the rectification section common mass transfer region located above the dividing wall or the stripping section common mass transfer region located below the dividing wall.

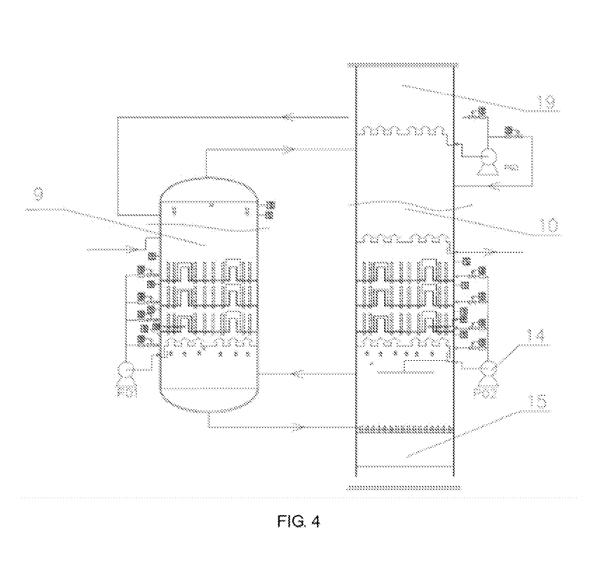

As shown in FIG. 4, the present invention provides a gas distribution structure for a distillation column. A left mass transfer region 9 and a right mass transfer region 10 are respectively located in separate column bodies. The left mass transfer region 9 is communicated with the right mass transfer region 10 through a pipeline. Specifically, the left mass transfer region 9 is communicated with the right mass transfer region 10 through the pipeline located in the rectification section common mass transfer region and/or the stripping section common mass transfer region. FIG. 4 shows that the stripping section common mass transfer region 15 is communicated with the rectification section common mass transfer region 19 in mass transfer regions on both sides through the pipeline.

The left mass transfer region 9 and the right mass transfer region 10 are respectively located in separate column bodies. A twin-column distillation column structure is a traditional rectification apparatus, reduces the workload of welding internal parts of the column compared with a single-column shell dividing wall column, further can avoid a complicated internal part structure of the column, is convenient for installation and maintenance, particularly for columns having a diameter smaller than 1000 mm, and overcomes a problem of insufficient installation and maintenance space. In addition, the distillation column with a twin-column structure is adopted to overcome a heat transferring problem because temperatures of both sides of the dividing wall of the single-column shell dividing wall column are not uniform, and further overcome problems of gas sealing and thermal stress deformation when the dividing wall is fixed. However, the problem that the gas-liquid distribution on the left side and the right side is not uniform also exists in the twin-column distillation column during rectification of a multicomponent material. The distribution of the gas on both sides of the dividing wall involves a series of calculation processes such as complex hydraulic calculation, dynamic simulation of operating parameters, analysis of a gas-liquid two-phase flow field, etc. The gas distribution structure of the present invention is arranged in the distillation column with the twin-column structure so that the gas can also be distributed and controlled precisely in a left column body and a right column body.

In a specific embodiment, as shown in FIG. 5, the top of each downcomer 7 is higher than the uppermost sieve hole 17 in the cover hood 6. A pressure drop is increased with the increase of a liquid level. When the liquid level above the pressure drop adjusting column tray 4 is higher than the sieve hole 17, the sieve holes 17 in the cover hood 6 are completely covered by liquid, and the gas in the gas-rising pipes 5 can only penetrate through a liquid layer and overflow at this time, so the pressure drop is further increased. Specifically, when the highest position of the sieve hole 17 in the cover hood 6 is level with the top of the gas-rising pipe, the downcomers 7 and the gas-rising pipes 5 are arranged in such a manner that the tops of the downcomers 7 are higher than the tops of the gas-rising pipes 5. When the liquid completely covers the sieve holes 17, the liquid level is further increased. The resistance adjustment effect is directly related to the increased liquid level. Specifically, the top of each downcomer is 30-60 mm higher than the uppermost sieve hole in the cover hood.

The numbers P and Q of the downcomers 7 and the gas-rising pipes 5 are respectively 1-100, and preferably 1-20. The number P of the downcomers 7 and the number Q of the gas-rising pipes 5 may be the same or different. In a specific embodiment, the number P of the downcomers is greater than the number Q of the gas-rising pipes. The downcomers are distributed on both sides of the gas-rising pipes. It should be known by those skilled in the art that the number of downcomers and the number of the gas-rising pipes can also be set in a manner of being greater than 100 according to actual conditions (such as a scale of an apparatus and other factors).

In a specific embodiment of the present invention, the control system can be a distributed control system (DCS). All the gas flow meters 3 and the liquid flow meters 12 transmit signals to the DCS. The circulation pumps 14 and the adjusting valves 13 are controlled by the DCS. The DCS has a strong control function and high reliability, also has high flexibility and coordinability, can rapidly and accurately process the collected signals, and immediately adjusts and controls the circulation pumps and the adjusting valves. It should be known by those skilled in the art that the control system is not only limited to the DCS, and can also be a programmable logic controller (PLC), a fieldbus control system (FCS) or the like.

In a specific embodiment of the present invention, the numbers of layers of the pressure drop adjusting column tray assemblies are respectively M and N. M is greater than or equal to 0 and less than or equal to 20; N is greater than or equal to 0 and less than or equal to 20; and M and N are integers and are not equal to 0 at the same time. In a specific embodiment of the present invention, M and N are respectively an integer of 1-10, for example, 2, 3, 4, 5, 6, 7, 8 and 9 layers. M and N may be the same and may also be different. When M or N is greater than 1, two or more layers of pressure drop adjusting column tray assemblies are respectively located between two adjacent mass transfer regions. It should be known by those skilled in the art that the number of the pressure drop adjusting column tray assemblies can be adjusted according to actual demands (for example, according to composition, nature and content of a component to be separated, separation precision of a product, operating flexibility of an apparatus, resistance size of a mass transfer section and hydrodynamic characteristics of internal parts). When a plurality of layers of pressure drop adjusting column tray assemblies are adopted, the liquid levels of various layers are adjusted to produce different influences on change of gas flow. When the liquid level of a region of a pressure drop adjusting column tray assembly is adjusted by the adjusting valve, the liquid levels of the region corresponding to the pressure drop adjusting column tray assembly and various layers below the pressure drop adjusting column tray are changed, and the pressure drop in the corresponding mass transfer region is changed. The liquid levels of various layers located above the mass transfer region corresponding to the pressure drop adjusting column tray assembly are not affected. Since adjustment and control capabilities of various layers of assemblies are different, the gas flow or the pressure drop is slightly or greatly adjusted and controlled precisely by combined adjustment and control of the pressure drop adjusting column tray assemblies at different positions.

In a specific embodiment of the present invention, an inner diameter of the gas-rising pipe 5 is 30 mm-300 mm according to the size of the diameter of the column and the volume of the gas. The height from the top of the gas-rising pipe 5 to an upper plane of the pressure drop adjusting column tray 4 is 50 mm-250 mm according to the volume of the liquid. It should be known by those skilled in the art that the above parameters are only used for giving a more preferred size range, rather than playing a role of limiting.

In a specific embodiment of the present invention, the diameter of the downcomer 16 is 0.5-10 mm. The number of the liquid-falling holes 16 in each row is 1-5. The downcomers 7 are one of square pipes, circular pipes and elliptical pipes. It should be known by those skilled in the art that the shapes of the downcomers are not limited to the above shapes and can also be other shapes, such as rectangles, trapezoids, polygons, etc. capable of realizing similar functions of the downcomers of the present invention. It should also be known by those skilled in the art that the diameter, number and size of the liquid-falling holes can also be adjusted according to actual demands.

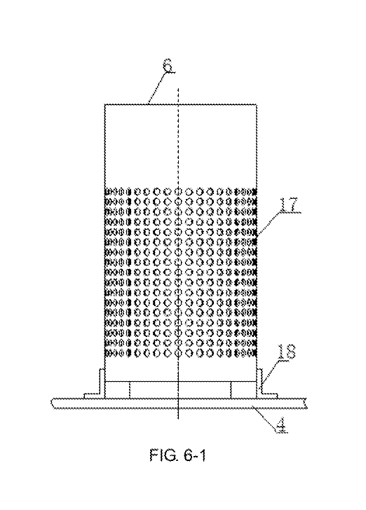

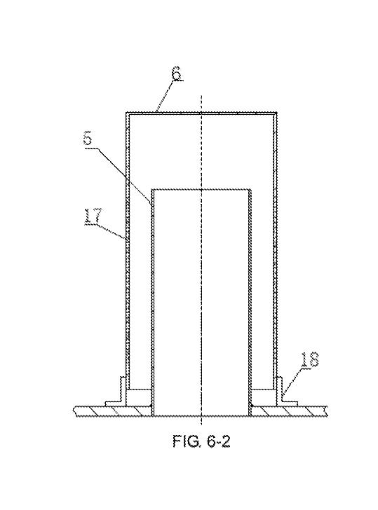

In a specific embodiment of the present invention, the cover hood 6 is fixed in such a manner that a plurality of supporting rib plates 18 are arranged at the bottom of each cover hood 6; as shown in FIG. 6-1 and FIG. 6-2, the cover hood 6 is arranged coaxially with the gas-rising pipe 5 on which the cover hood is located; the cover hood 6 is welded with the pressure drop adjusting column tray 4 by the supporting rib plates 18; it is better to reserve a gap between the bottom of the cover hood 6 and the pressure drop adjusting column tray 4 during welding; and the gap is 5-30 mm. A gap of 10-50 mm is formed between the top of the cover hood 6 and the top of the gas-rising pipe 5. The sieve holes 17 are of a circular, square, rhombic or elliptical shape. A plurality of sieve holes 17 are distributed along a height direction of the cover hood in a plurality of rows. Each row has at least one sieve hole. Specifically, each row has a plurality of sieve holes. The distribution of the sieve holes is not limited to uniform arrangement, and can also be irregular arrangement. The shapes of the downcomers can also be other shapes. It should be known by those skilled in the art that the size of the gap and the shapes of the sieve holes and the cover hoods are only preferred embodiments of the present invention and are not used for limiting the present invention.

In a specific embodiment of the present invention, the numbers of the liquid collecting regions in the left mass transfer region and the right mass transfer region are J and K, wherein J is greater than or equal to 0 and less than or equal to 20; K is greater than or equal to 0 and less than or equal to 20; and J and K are integers and are not equal to 0 at the same time. Specifically, the numbers J and K of the liquid collecting regions are integers greater than or equal to 1 respectively, can be the same as the number of the pressure drop adjusting column tray assemblies, and can also be less than the number of the pressure drop adjusting column tray assemblies.

In a specific embodiment of the present invention, gas-rising cap column trays 2 are arranged in the liquid collecting regions. A liquid accumulating type liquid-falling groove is formed between a side surface of each gas-rising cap column tray 2 and the column wall 1. A liquid collecting port is formed in a position on the column wall 1 and on a lower side surface of each liquid accumulating type liquid-falling groove. The height of a groove plate of the liquid accumulating type liquid-falling groove is 300-800 mm. Specifically, the gas-rising cap column trays 2 are of a chimney shape. It should be known by those skilled in the art that the shape of the gas-rising cap column tray is not limited to the chimney shape and can also be of rectangular, arc or other shapes.

In a specific embodiment of the present invention, in order to improve the detection precision of the gas flow meters and further improve the gas distribution precision, pressure gauges 11 and thermometers can be arranged. Specifically, the pressure gauges 11 are arranged in regions formed between adjacent pressure drop adjusting column trays 4. The thermometers are respectively arranged at positions of sensitive plates in the left mass transfer region 9 and the right mass transfer region 10. Materials at different temperatures or pressures have different boiling points. In order to further improve the gas distribution precision and then improve the rectification precision and save energy consumption, the pressure gauges and the thermometers are adopted to measure the current differential pressure and temperature, to precisely adjust and control the gas distribution in combination with gas flow parameters measured by the gas flow meters.

In a specific embodiment of the present invention, by taking the dividing wall type distillation column as an example, the position of the liquid collecting region may comprise one or more of the following situations:

1) The liquid collecting region is located between the stripping section common mass transfer region and the lowermost pressure drop adjusting column tray assembly; at this time, a circulation pump 14 is connected outside the liquid collecting port; and all the feeding ports are connected to the circulation pump 14 through a circulation pipeline, as shown in FIG. 3-1.

2) The liquid collecting region is located below the lowermost pressure drop adjusting column tray assembly between adjacent mass transfer regions; at this time, the circulation pump 14 is connected outside the liquid collecting port; and all the feeding ports between the adjacent mass transfer regions are respectively connected to the circulation pump 14 through the circulation pipeline, as shown in FIG. 3-2.

3) The liquid collecting region is located below the pressure drop adjusting column tray 4 of the pressure drop adjusting column tray assembly; at this time, the circulation pump 14 is connected outside the liquid collecting port below the pressure drop adjusting column tray 4; and the feeding port located above the pressure drop adjusting column tray 4 is connected to the circulation pump 14 through the circulation pipeline, as shown in FIG. 3-3.

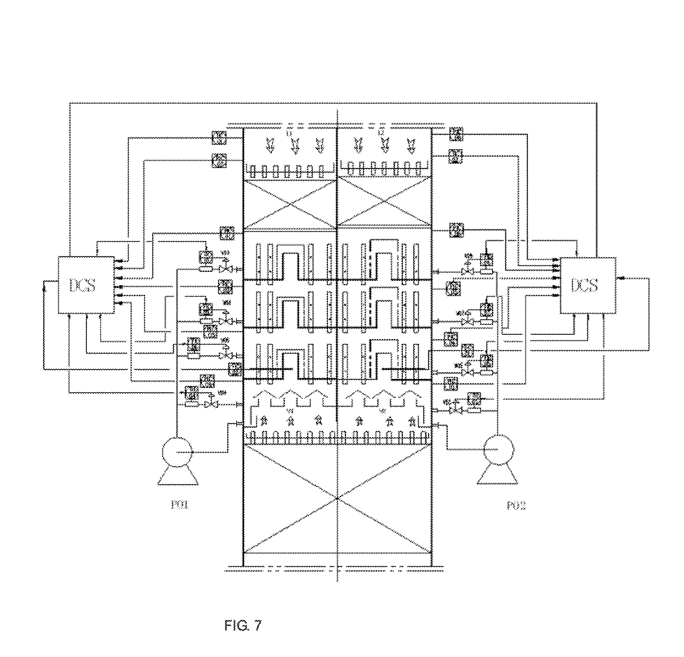

The present invention proposes a method for realizing gas distribution and control of a distillation column by using the gas distribution structure. By taking the dividing wall type distillation column as an example, as shown in FIG. 7, the gas distribution and control of the distillation column are realized through the coordination effect of the circulation pumps 14, the adjusting valves 13, the flow meters and the control system (such as, the DCS which is interchangeable with the control system in the following embodiments and specific embodiments) in the gas distribution structure of the present invention. By taking the DCS as an example, the DCS controls the circulation pumps 14 and the adjusting valves 13. The liquid flow meters 12 and the gas flow meters 3 feed back the current technological parameters to the DCS. The DCS issues a command for controlling the circulation pumps 14 and the adjusting valves 13 again according to a set technological control target until the fed-back technological parameters meet the technological control target. In the entire control process, the change of a liquid flow of each layer of pressure drop adjusting column tray 4 can control a gas phase circulation area and a gas-liquid contact form, and then is converted into a gas phase flowing resistance drop, so as to effectively adjust and control a gas distribution ratio of regions on both sides of the dividing wall 8.

In a specific embodiment of the present invention, when the gas distribution structure comprises the pressure gauges and the thermometers, the pressure gauges and the thermometers feed back the current technological parameters to the control system. The pressure gauges and the thermometers are adopted to measure the current differential pressure and temperature, to precisely adjust and control the gas distribution in combination with gas flow parameters measured by the gas flow meters.

In an operation process of adjusting and controlling the pressure drop of the gas distribution structure of the present invention, as shown in FIG. 5, the liquid-falling capability of the downcomers 7 depends on the size, number, position and liquid layer height of the liquid-falling holes 16 formed in the downcomers 7. Thus, when the size and the structure of the downcomers 7 are established, the liquid-falling capability of the downcomers 7 is mainly affected by means of the liquid level height. The gas flow meters 3 transmit gas flow signals to the DCS in real time. The DCS controls the adjusting valves 13 and the circulation pumps 14. When the liquid flow controlled by the adjusting valves 13 is increased, the liquid flow flowing from the feeding ports to the pressure drop adjusting column trays 4 will be increased, and the liquid layer height H on the pressure drop adjusting column trays 4 will be increased. After the liquid layer height is increased, some sieve holes 17 in the side wall of the cover hood 6 are submerged by the liquid, so that the number of the sieve holes available for gas circulation is reduced, which means that the gas circulation area is correspondingly reduced, and the gas flowing resistance is correspondingly increased, namely, the pressure drop of the pressure drop adjusting column trays 4 is increased. When the liquid layer is increased and all the sieve holes 17 are submerged by the liquid level, the gas can only penetrate through the liquid layer and some sieve holes 17 below the liquid level. A gas flowing resistance coefficient is rapidly increased with the thickness of the liquid layer, and then the pressure drop of the layer of pressure drop adjusting column tray 4 is rapidly increased. The coordination effect of the gas-rising pipes 5, the cover hoods 6 and the liquid-falling pipes 7 in the present invention has a main function for controlling the pressure drops of the pressure drop adjusting column trays by change of the liquid level. Meanwhile, the liquid above the pressure drop adjusting column tray assemblies flows circularly through circulation assemblies (comprising the circulation pipelines, the circulation pumps, valves arranged on the circulation pipelines and the like). Although the gas phase and the liquid phase may be in contact with each other, the gas phase and the liquid phase are not used for heat transfer and mass transfer. But for the traditional gas-liquid mass transfer column tray, the gas must pass through the liquid layer, and the heat transfer and mass transfer are performed after the gas is in full contact with the liquid. Thus, the pressure drop adjusting column tray assemblies of the present invention are fundamentally different from traditional gas-liquid mass transfer column trays in both structure and achievable function.

A gas adjustment and control process on both sides of the dividing wall of the distillation column having the gas distribution structure of the present invention is as follows (taking the dividing wall type distillation column as an example):

As shown in FIG. 7, the gas distribution and control of the dividing wall type distillation column are realized through the coordination effect of the circulation pumps 14, the adjusting valves 13, the flow meters, the pressure gauges 11, the thermometers and the DCS in the gas distribution structure of the present invention. The DCS controls the circulation pumps 14 and the adjusting valves 13. The liquid flow meters 12, the gas flow meters 3, the pressure gauges 11 and the thermometers feed back the current technological parameters to the DCS. The DCS issues a command for controlling the circulation pumps 14 and the adjusting valves 13 again according to a set technological control target until the fed-back technological parameters meet the technological control target. In the entire control process, the change of a liquid flow of each layer of pressure drop adjusting column tray 4 can control a gas phase circulation area and a gas-liquid contact form, and then is converted into a gas phase flowing resistance drop, so as to effectively adjust and control a gas distribution ratio of regions on both sides of the dividing wall 8.

Further, during normal operation, both the liquid distribution and the gas distribution on the left side and the right side of the dividing wall 8 of the dividing wall type distillation column have an optimum value interval. The intervals of the left side and the right side of the dividing wall 8 are different in range according to different material natures and separation requirements. Like an ordinary distillation column, the dividing wall type distillation column cannot keep steady state operation for a long time, but adjusts and controls according to changes of various external technological parameter variables. For example, after the feed composition is changed, as shown in FIG. 3-1 and FIG. 7, the distribution ratio of liquid L1 to liquid L2 on the left side and the right side of the dividing wall needs to be adjusted. The adjustment of the liquid distribution ratio will inevitably affect the gas flowing resistance on the left side and the right side and then affect gas flows V1 and V2 on both sides of the dividing wall. Thus, the distribution ratio of the gases on both sides of the dividing wall needs to be adjusted by using a pressure drop adjusting apparatus. A control strategy of the dividing wall type distillation column is selected by combining situations of temperatures (which can be obtained by the thermometers TIC01 and TIC02) of positions of the sensitive plates on both sides of the dividing wall 8 and technological parameters (which can be obtained by the liquid flow meters 12, the pressure gauges 11 and the gas flow meters 3) of the whole column. The DCS adjusts the liquid circulation amount of the pressure drop adjusting column tray regions on both sides of the dividing wall 8 according to real-time data parameters so as to control the thickness of the liquid layer on the pressure drop adjusting column tray, and is matched with a structure combining the gas-rising pipes 3 with the cover hoods 6 so as to achieve objectives of regulating and controlling the gas flowing resistance and changing the gas flow distribution ratio.

The structure of the embodiment shown in FIG. 3-1 is taken as an example below and is described in detail according to different adjustment and control objectives as follows:

Embodiment 1: the gas flow (of the gas flow meter FIC02) in the left mass transfer region of the dividing wall needs to be reduced by 30%.

Firstly, a left circulation pump P01 is started; a left adjusting valve V10 is started by the DCS; a valve opening is adjusted to 50%; the liquid level H of the column tray is adjusted by pressure drops of three layers of column trays on the left side; the liquid level of the column tray is gradually increased from a normal value 50 mm to 100 mm; 50% of the sieve holes 17 in the cover hoods 6 are submerged by the liquid; the pressure drops of the three layers of column trays are monitored by DCS through PIC01 (Pressure Identify & Control, pressure gauge), PIC02, PIC03 and PIC09, the pressure drop of each layer is gradually increased to 120 Pa; the opening of the adjusting valve and the gas phase flow are jointly adjusted; the gas flow V1 on the left side is decreased rapidly; readings of TIC01 and TIC02 are monitored; after the FIC02 shows that the decreased value of the flow is close to 20%, the V10 is continuously slightly adjusted and controlled until the system is stable; and the adjustment and control for the V10 are stopped after the stable state is maintained for 10 min.

Then, an adjusting valve V08 is started by the DCS; the DCS automatically monitors the change of the flow FIC02, the valve opening is adjusted to 25%; the liquid level H of the second layer and the third layer of column trays is increased from 100 mm to 125 mm; 75% of the sieve holes 17 in the cover hoods 6 are submerged by the liquid; the pressure drops of the second layer and the third layer of column trays are gradually increased to 150 Pa; after the flow V1 is gradually decreased to 28%, the readings of TIC01 and TIC02 are monitored; the V10 is continuously slightly adjusted and controlled until the system is stable; and the adjustment and control for the FICV10 are stopped after the stable state is maintained for 10 min.

Finally, an adjusting valve V06 is started by the DCS; the system automatically monitors the change of the flow FIC02, the valve opening is adjusted to 5%; the liquid level H of the third layer of column tray is increased from 125 mm to 130 mm; 80% of the sieve holes 17 in the cover hoods 6 on the third layer of column tray are submerged by the liquid; the pressure drop of the third layer of column tray is gradually increased to 170 Pa; after the flow is gradually decreased to 30%, the system continuously adjusts and controls the V06 slightly until the system is table; the readings of TIC01 and TIC02 are monitored; and the adjustment and control for the V06 are stopped after the stable state is maintained for 10 min.

Embodiment 2: the gas flow V1 (of the gas flow meter FIC02) in the left mass transfer region of the dividing wall needs to be reduced by 20%, and the gas flow V2 (of the gas flow meter FIC01) on the right side of the dividing wall is increased by 20%.

Firstly, a left circulation pump P01 is started by the DCS; a left adjusting valve V10 is started; the valve opening is adjusted to 35%; the liquid level H of the column tray is adjusted by pressure drops of three layers of column trays on the left side; the liquid level H of the column tray is increased from a normal value 50 mm to 85 mm, 35% of the sieve holes 17 in the cover hoods 6 are gradually submerged by the liquid; the pressure drops of the three layers of column trays are detected by PIC01, PIC02, PIC03 and PIC09, the pressure drop of each layer of three layers of column trays is gradually increased to 80 Pa; the opening of the adjusting valve and the gas phase flow are jointly adjusted; the gas flow V1 on the left side is decreased rapidly; readings of TIC01 and TIC02 are monitored at the same time; after the FIC02 shows that the decreased value of the flow is close to 12%, the V10 is continuously slightly adjusted and controlled until the system is stable; and the adjustment and control for the V10 are stopped after the stable state is maintained for 10 min.

Then, an adjusting valve V08 is started by the DCS; the DCS automatically monitors the change of the flow FIC02, the valve opening is adjusted to 15%; the liquid level H of the second layer and the third layer of column trays is increased from 85 mm to 110 mm; 60% of the sieve holes 17 in the cover hoods 6 are submerged by the liquid; the pressure drops of the second layer and the third layer of column trays are gradually increased to 120 Pa; after the flow is gradually decreased to 18%, the readings of TIC01 and TIC02 are monitored; the V10 is continuously slightly adjusted and controlled until the system is stable; and the adjustment and control for the FICV10 are stopped after the stable state is maintained for 10 min.

Finally, an adjusting valve V06 is started; the DCS automatically monitors the change of the flow FIC02, the valve opening is adjusted to 5%; the liquid level H of the third layer of column tray is increased from 110 mm to 120 mm; 70% of the sieve holes 17 in the cover hoods 6 on the third layer of column tray are submerged by the liquid; the pressure drop of the third layer of column tray is gradually increased to 140 Pa; after the flow V1 is gradually decreased to 30%, the system continuously adjusts and controls the V06 slightly until the system is table; the readings of TIC01 and TIC02 are monitored; and the adjustment and control for the V06 are stopped after the stable state is maintained for 10 min.

Embodiment 3: adjustment and control objective: the gas flow V1 (of the gas flow meter FIC02) in the left mass transfer region of the dividing wall needs to be reduced by 5%.

Firstly, a left circulation pump P01 is started by the DCS; a left adjusting valve V10 is started; the valve opening is adjusted to 15%; the liquid level H of the column tray is adjusted by pressure drops of three layers of column trays on the left side; the liquid level H of the column tray is increased from a normal value 50 mm to 65 mm, 15% of the sieve holes 17 in the cover hoods 6 are submerged by the liquid; the pressure drops of the three layers of column trays are monitored by PIC01, PIC02, PIC03 and PIC09, the pressure drop of each of the three layers of column trays is increased to 50 Pa; the opening of the adjusting valve and the gas phase flow are jointly adjusted; the gas flow V1 on the left side is decreased rapidly; readings of TIC01 and TIC02 are monitored at the same time; after the FIC02 shows that the decreased value of the flow is close to 4%, the V10 is continuously slightly adjusted and controlled until the system is stable; and the adjustment and control for the V10 are stopped after the stable state is maintained for 10 min.

Then, an adjusting valve V06 is started by the DCS; the DCS automatically monitors the change of the flow FIC02, the valve opening is adjusted to 5%; the liquid level H of the third layer of column tray is increased from 65 mm to 85 mm; 25% of the sieve holes 17 in the cover hoods 6 are submerged by the liquid; the pressure drop of the third layer of column tray is gradually increased to 100 Pa; after the flow is gradually decreased to 5%, the readings of TIC01 and TIC02 are monitored; the V06 is continuously slightly adjusted and controlled until the system is stable; and the adjustment and control for the V06 are stopped after the stable state is maintained for 10 min.

Embodiment 4: adjustment and control objective: the backflow volume L1 of the left side mass transfer region (the internal parts of the mass transfer region of the present embodiment are fillers) is doubled; the gas resistance on the left side of the dividing wall is increased; the flow starts to decrease; and the gas flow (of the gas flow meter FIC02) on the left side of the dividing wall needs to be increased by 20% according to the technological control parameters.

Firstly, a right circulation pump P02 is started by the DCS; a right adjusting valve V09 is started; the valve opening is adjusted to 35%; the liquid level of the column tray is adjusted by pressure drops of three layers of column trays on the right side; the liquid level H of the column tray is increased from a normal value 50 mm to 85 mm; 35% of the sieve holes 17 in the cover hoods 6 are gradually submerged by the liquid; the pressure drops of the three layers of column trays on the right side of the dividing wall are monitored by PIC04, PIC05, PIC06 and PIC10, the pressure drop of each of the three layers of column trays is increased to 80 Pa; the opening of the adjusting valve and the gas phase flow are jointly adjusted; the gas flow V2 on the right side is decreased rapidly; readings of TIC01 and TIC02 are monitored at the same time; after the FIC02 shows that the increased value of the flow is close to 12%, the V09 is continuously slightly adjusted and controlled until the system is stable; and the adjustment and control for the V09 are stopped after the stable state is maintained for 10 min.

Then, an adjusting valve V07 is started by the DCS; the DCS automatically monitors the change of the flow FIC02, the valve opening is adjusted to 15%; the liquid level H of the second layer and the third layer of column trays is increased from 85 mm to 110 mm; 60% of the sieve holes 17 in the cover hoods 6 are submerged by the liquid; the pressure drops of the second layer and the third layer of column trays are gradually increased to 120 Pa; after the flow is gradually increased to 18%, the readings of TIC01 and TIC02 are monitored; the V07 is continuously slightly adjusted and controlled until the system is stable; and the adjustment and control for the V07 are stopped after the stable state is maintained for 10 min.

Finally, an adjusting valve V05 is started; the DCS automatically monitors the change of the flow FIC02, the valve opening is adjusted to 5%; the liquid level H of the third layer of column tray on the right side of the dividing wall is increased from 110 mm to 120 mm; 70% of the sieve holes 17 in the cover hoods 6 on the third layer of column tray are submerged by the liquid; the pressure drop of the third layer of column tray is gradually increased to 140 Pa; after the flow is gradually decreased to 30%, the system continuously adjusts and controls the V05 slightly until the system is table; the readings of TIC01 and TIC02 are monitored; and the adjustment and control for the V05 are stopped after the stable state is maintained for 10 min.

Although the structure of embodiment 1 shown in FIG. 3-1 and FIG. 7 is taken as an example in embodiments described above, the gas distribution and control for the structure of embodiment shown in FIG. 3-2 and FIG. 3-3 have the same principle, can be realized by those skilled in the prior art and is not repeated herein.

PCT of the present application is disclosed in Chinese, and may have some differences due to different word processing manners in different languages when translated in a subsequent stage of entering other countries. But these differences should not become reasons for affecting the scope of the present invention. For example, when the present application is translated from Chinese to English, all the translation differences caused by particular reference or non-particular reference, singular or plural form and the like belong to the protection scope of the present invention.

Although the present invention is described above in combination with the drawings, the present invention is not limited to the specific embodiments described above, and the specific embodiments described above are only illustrative and not restrictive. Any modification, equivalent substitution, improvement and the like made by those ordinary skilled in the art under the inspiration of the present invention without departing from the intention of the present invention belong to the protection scope of the present invention.

We claim:

1. A pressure drop adjusting column tray assembly for gas distribution of a distillation column, comprising pressure drop adjusting column trays (4), wherein downcomers (7) and gas-rising pipes (5) are penetrated on the pressure drop adjusting column trays (4); a plurality of rows of liquid-falling holes (16) are formed in a pipe wall of each downcomer (7); and a cover hood (6) provided with sieve holes (17) is arranged on each gas-rising pipe (5).

2. The pressure drop adjusting column tray assembly according to claim 1, wherein a top of each downcomer (7) is higher than the uppermost sieve hole (17) in the cover hood (6).

3. The pressure drop adjusting column tray assembly according to claim 1, wherein the number of the downcomers on each pressure drop adjusting column tray is P; P is greater than or equal to 1 and less than or equal to 100; P is an integer; the number of the gas-rising pipes on each pressure drop adjusting column tray is Q; Q is greater than or equal to 1 and less than or equal to 100; Q is an integer; preferably, the number P of the downcomers is greater than the number Q of the gas-rising pipes; and the downcomers are distributed on both sides of the gas-rising pipes.

4. The pressure drop adjusting column tray assembly according to claim 1, wherein the cover hood (6) is arranged coaxially with the gas-rising pipe (5) on which the cover hood (6) is located; the cover hood (6) is fixed to the pressure drop adjusting column tray (4); a gap is reserved between the bottom of the cover hood (6) and the pressure drop adjusting column tray (4); and a gap is reserved between the top of the cover hood (6) and the top of the gas-rising pipe (5).

5. A gas distribution structure for a distillation column, the distillation column comprising a control system, a left mass transfer region (9) and a right mass transfer region (10), wherein
the pressure drop adjusting column tray assemblies of claim 1 are arranged in the left mass transfer region (9) and/or the right mass transfer region (10) along a column height direction; at least one gas flow meter (3) is respectively in the left mass transfer region (9) and/or the right mass transfer region (10); the gas flow meters (3) are located in a pipe of any gas-rising pipe (5); a feeding port is arranged above each layer of pressure drop adjusting column tray (4); liquid collecting regions are respectively arranged in the left mass transfer region (9) and/or the right mass transfer region (10); liquid accumulating type liquid-falling grooves are formed in the liquid collecting regions; each liquid collecting region further comprises a liquid collecting port; a circulation pump (14) is communicated with each liquid accumulating type liquid-falling groove through the liquid collecting port; the feeding port is connected to the circulation pump (14) through a circulation pipeline; a liquid flow meter (12) and an adjusting valve (13) are arranged on the circulation pipeline; the gas flow meter (3) and the liquid flow meter (12) transmit signals to the control system; and the circulation pump (14) and the adjusting valve (13) are controlled by the control system.

6. The gas distribution structure according to claim 5, wherein the distillation column further comprises a rectification section common mass transfer region (19) and/or a stripping section common mass transfer region (15).

7. The gas distribution structure according to any one of claim 1, wherein the distillation column is a dividing wall type distillation column; the dividing wall type distillation column comprises a dividing wall; and the left mass transfer region and the right mass transfer region are arranged on a left side and a right side of the dividing wall.

8. The gas distribution structure according to claim 5, wherein the left mass transfer region and the right mass transfer region are respectively located in separate column bodies; and the left mass transfer region is communicated with the right mass transfer region through a pipeline.

9. The gas distribution structure according to any claim 5, wherein the numbers of layers of the pressure drop adjusting column tray assemblies in the left mass transfer region (9) and the right mass transfer region (10) are respectively M and N; M is greater than or equal to 0 and less than or equal to 20; N is greater than or equal to 0 and less than or equal to 20; M and N are integers and are not equal to 0 at the same time; and preferably, M and N are respectively an integer of 1-10.

10. The gas distribution structure according to claim 5, wherein the numbers of the liquid collecting regions in the left mass transfer region (9) of the dividing wall and the right mass transfer region (10) of the dividing wall are J and K; J is greater than or equal to 0 and less than or equal to 20; K is greater than or equal to 0 and less than or equal to 20; J and K are integers and are not equal to 0 at the same time; and preferably, J and K are respectively an integer of 1-10.

11. The gas distribution structure according to claim 5, wherein gas-rising cap column trays (2) are arranged in the liquid collecting regions; a liquid accumulating type liquid-falling groove is formed between a side surface of each gas-rising cap column tray (2) and the column wall (1) of the dividing wall type distillation column; a liquid collecting port is formed in a position on the column wall (1) and on a lower side surface of each liquid accumulating type liquid-falling groove; and a height of a groove plate of the liquid accumulating type liquid-falling groove is 300-800 mm.

12. The gas distribution structure according to claim 5, wherein the gas distribution structure further comprises pressure gauges (11) and thermometers; the pressure gauges are arranged in regions formed between adjacent pressure drop adjusting column trays; the thermometers are arranged in the left mass transfer region and the right mass transfer region; and the pressure gauges (11) and the thermometers transmit signals to the control system.

13. The gas distribution structure according to claim 5, wherein the position of the liquid collecting region comprises one or more of the following situations:
1) the liquid collecting region is located between the stripping section common mass transfer region (15) and the lowermost pressure drop adjusting column tray assembly;
2) the liquid collecting region is located below the lowermost pressure drop adjusting column tray assembly between adjacent mass transfer regions; and
3) the liquid collecting region is located below the pressure drop adjusting column tray (4) of the pressure drop adjusting column tray assembly;
when the position of the liquid collecting region is the above situation 1), a circulation pump (14) is connected outside the liquid collecting port; and all the feeding ports are connected to the circulation pump (14) through a circulation pipeline;
when the position of the liquid collecting region is the above situation 2), the circulation pump (14) is connected outside the liquid collecting port; and all the feeding ports between the adjacent mass transfer regions are respectively connected to the circulation pump (14) through the circulation pipeline; and
when the position of the liquid collecting region is the above situation 3), the circulation pump (14) is connected outside the liquid collecting port below the pressure drop adjusting column tray (4); and the feeding port located above the pressure drop adjusting column tray (4) is connected to the circulation pump (14) through the circulation pipeline.

14. A gas distribution structure for a dividing wall type distillation column, the dividing wall type distillation column comprising a column wall (1), a dividing wall (8), a multi-section mass transfer region, a control system and at least one liquid collecting region and the multi-section mass transfer region comprising a rectification section common mass transfer region arranged above the dividing wall, a left mass transfer region (9) of the dividing wall, a right mass transfer region (10) of the dividing wall and a stripping section common mass transfer region (15) arranged below the dividing wall, wherein
several layers of pressure drop adjusting column tray assemblies are arranged in the left mass transfer region (9) of the dividing wall and the right mass transfer region (10) of the dividing wall and between two adjacent mass transfer regions along a column height direction; the pressure drop adjusting column tray assemblies comprise pressure drop adjusting column trays (4); a plurality of downcomers (7) and a plurality of gas-rising pipes (5) are fixed on the pressure drop adjusting column trays (4) in a penetrating manner and are arranged in such a manner that a top of each downcomer is higher than a top of each gas-rising pipe; a plurality of rows of liquid-falling holes (16) are formed in a pipe wall of each downcomer (7); a cover hood (6) provided with sieve holes (17) is arranged on each gas-rising pipe (5); a gas flow meter (3) is arranged in each of the left mass transfer region (9) of the dividing wall and the right mass transfer region (10) of the dividing wall; the gas flow meter (3) is located in a pipe of one gas-rising pipe (5);
feeding ports are respectively formed in a column wall and above the pressure drop adjusting column tray (4) of each layer of pressure drop adjusting column tray assembly;
a chimney type gas-rising cap column tray (2) is arranged in each liquid collecting region; a liquid accumulating type liquid-falling groove is formed between a side surface of each chimney type gas-rising cap column tray (2) and the column wall; a liquid collecting port is formed in a position on the column wall and on a lower side surface of each liquid accumulating type liquid-falling groove;
the position of the liquid collecting region comprises one or more of the following situations:
1) the liquid collecting region is located between the stripping section common mass transfer region (15) and the lowermost pressure drop adjusting column tray assembly;
2) the liquid collecting region is located below the lowermost pressure drop adjusting column tray assembly between adjacent mass transfer regions; and
3) the liquid collecting region is located below the pressure drop adjusting column tray (4) of the pressure drop adjusting column tray assembly;
when the position of the liquid collecting region is the above situation 1), a circulation pump (14) is connected outside the liquid collecting port; and all the feeding ports are respectively connected to the circulation pump (14) through a circulation pipeline;
when the position of the liquid collecting region is the above situation 2), the circulation pump (14) is connected outside the liquid collecting port; and all the feeding ports between the adjacent mass transfer regions are respectively connected to the circulation pump (14) through the circulation pipeline;
when the position of the liquid collecting region is the above situation 3), the circulation pump (14) is connected outside the liquid collecting port below the pressure drop adjusting column tray (4); and the feeding port located above the pressure drop adjusting column tray (4) is connected to the circulation pump (14) through the circulation pipeline;
a liquid flow meter (12) and an adjusting valve (13) are sequentially arranged on each circulation pipeline from the circulation pump to the feeding port; pressure gauges (11) are arranged in regions formed between adjacent pressure drop adjusting column trays (4);
thermometers are respectively arranged at positions of sensitive plates in the left mass transfer region (9) of the dividing wall and the right mass transfer region (10) of the dividing wall; and
all the gas flow meters (3), liquid flow meters (12), pressure gauges (11) and thermometers transmit signals to the control system; and the circulation pumps and the adjusting valves are controlled by the control system.

15. A method for gas distribution and control of a distillation column, using the gas distribution structure for the distillation column of claim 5, wherein the control system controls the circulation pumps (14) and the adjusting valves (14); the liquid flow meters (12) and the gas flow meters (3) feed back current technological parameters to the control system; and the control system issues a command for controlling the circulation pumps (14) and the adjusting valves (13) again according to a set technological control target until the fed-back technological parameters meet the technological control target.

16. A method for gas distribution and control of a distillation column, using the gas distribution structure for the distillation column of claim 14, wherein the control system controls the circulation pumps (14) and the adjusting valves (14); the liquid flow meters (12) and the gas flow meters (3) feed back current technological parameters to the control system; and the control system issues a command for controlling the circulation pumps (14) and the adjusting valves (13) again according to a set technological control target until the fed-back technological parameters meet the technological control target.
